(19) United States
(12) Patent Application Publication
(10) Pub. No.: US 2007/0029947 A1
(43) Pub. Date: Feb. 8, 2007

(54) Inverter driving circuit

(75) Inventors: Chin-Wen Chou, Taipei Hsien (TW); Ying-Nan Cheng, Taipei Hsien (TW); Kuang-Ming Wu, Taipei Hsien (TW); Chin-Biau Chung, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/194,583

(22) Filed: Aug. 2, 2005

(51) Int. Cl. H05B 41/36

(52) U.S. Cl. 315/291

(57) ABSTRACT

An inverter driving circuit includes a micro-controller and a PWM control unit to replace the double PWM control units adopted in conventional techniques. A voltage feedback signal may be captured from a connection line which links an inverter and a load. The voltage feedback signal is sent to the micro-controller to output a protection signal which activates the PWM control unit to output an electricity conduction cycle signal thereby to provide protection while the inverter driving voltage is abnormal.

### FIELD OF THE INVENTION

The present invention relates to an inverter driving circuit and particularly to an inverter driving circuit for regulating luminance of a light source and protecting abnormal driving voltage.

### BACKGROUND OF THE INVENTION

Electricity control techniques for inverters are known in the art. U.S. Pat. No. 6,791,239 proposed by the Applicant is such an example. That technique focuses on the conventional inverter circuit and includes an individual pulse-width modulation (PWM) control unit, a driving unit, and a voltage boosting unit to drive an individual discharge lamp (CCFL or EEFL). As the size of display panels increases gradually, the number of the discharge lamps also increases. The required electricity increases too. Hence the size of circuit board to accommodate the configuration of the PWM control unit, driving unit and voltage boosting unit made according to the number of discharge lamps is larger, and circuit layout and production are more difficult. Illumination and electric field interference among the discharge lamps also increases. As a result, luminance uniformity suffers. While the aforesaid technique provides a solution, it mainly aims to provide, through a single PWM control unit, synchronous driving signals of the same phase and same frequency according to the driving units and voltage boosting units that are required to drive the discharge lamps on the rear end. Thereby each driving unit, voltage boosting unit and discharge lamp can be driven synchronously to achieve uniform luminance.

U.S. Pat. No. 6,867,955 and U.S. patent publication No. 2005/0122066 A1 disclose other techniques to address the arc discharge phenomenon occurred to an inverter at a high voltage output zone in abnormal conditions. They provide a protection device which generates a protection signal fed back to a control unit to stop high voltage output in the high voltage output zone.

In the aforesaid techniques, the PWM control unit can be connected to another PWM control unit which outputs a dimming duty cycle as shown in FIG. 1. But in the existing techniques the protection signal is difficult to differentiate due to signals of component voltage. Hence a signal amplifier or a silicon rectifier has to be added to enable the PWM control-unit on the rear end to accurately differentiate the output of interruption electricity conduction cycle signal. However, this approach could result in the risk of time delay or differentiation error. Moreover, adding more electronic. elements such as the signal amplifier or silicon rectifier on the power line also creates wire layout problem of the entire circuit configuration.

### SUMMARY OF THE INVENTION

Therefore the primary object of the present invention is to solve the aforesaid problems. The invention provides an inverter driving circuit which is capable of regulating luminance of a light source and protecting abnormal driving voltage. It mainly includes a micro-controller and a PWM control unit to replace the double PWM control units of the conventional techniques. By means of the invention, a voltage feedback signal is captured from the connection line which bridges a load and a driving inverter and is directly input to the micro-controller. The micro-controller is triggered to output a protection signal to activate the PWM control unit. The PWM control unit outputs or suspends an electricity conduction cycle signal to provide protection while the inverter driving voltage is abnormal.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a conventional inverter driving circuit.

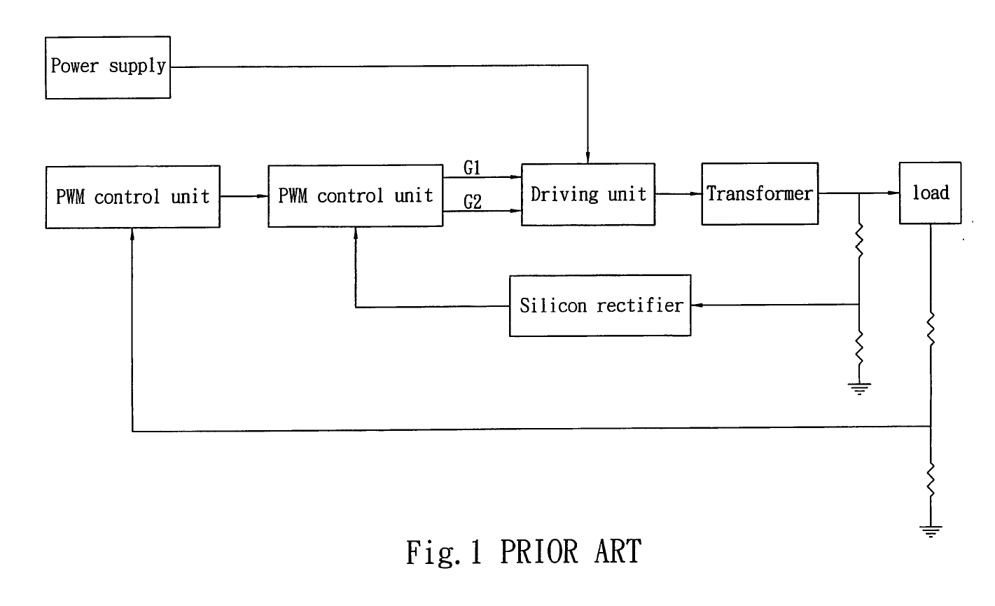

FIG. 2 is a block diagram of the inverter driving circuit of the present invention.

### DETAILED DESCRIPTION OF THE PREFERRED EMBODIMENT

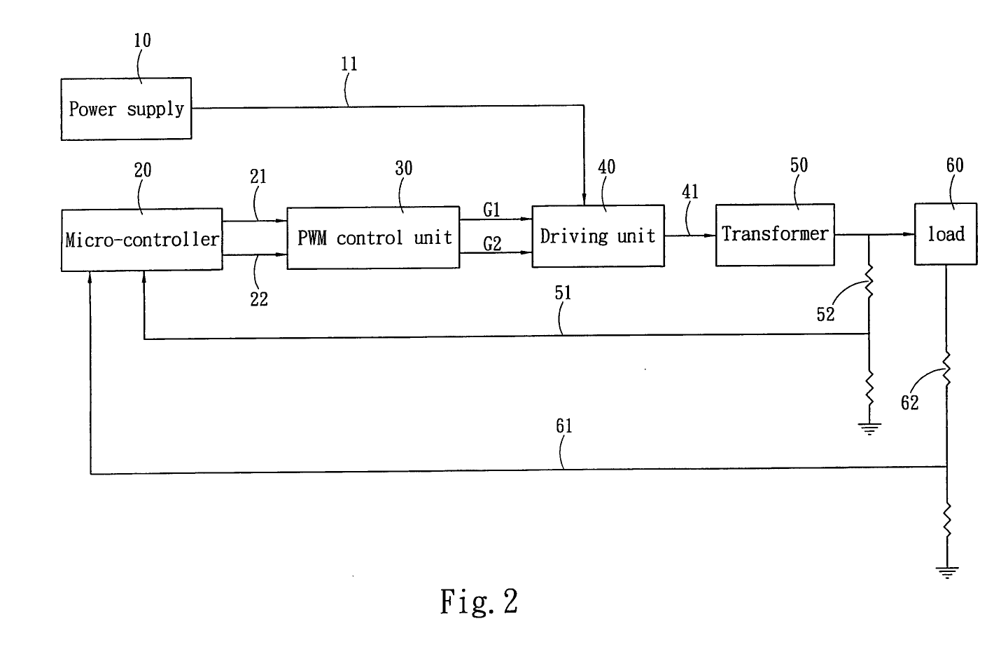

Please refer to FIG. 2 for the block diagram of the inverter driving circuit of the invention. The invention aims to provide an inverter driving circuit that electrically connects a power supply 10 and a load 60. The power supply 10 is pulse-width DC or stabilized DC that has been rectified. The load 60 may be a discharge lamp such as a cold cathode fluorescent lamp (CCFL) or external electrode fluorescent lamp (EEFL). The inverter driving circuit of the invention includes a micro-controller (microchip) 20 which receives an external dimming signal to output a dimming duty cycle 21 and a protection signal 22. The micro-controller 20 receives or outputs the signals through a logic process and determination mode. The micro-controller 20 is electrically connected to a PWM control unit 30 on a rear end that receives the dimming duty cycle 21 to output a PWM signal with electricity conduction cycles G1 and G2, and is activated by the protection signal 22. The PWM control unit 30 is connected to a driving unit (MOSFET) 40 which receives the electricity conduction cycles G1 and G2, and switches input electricity 11 of the power supply 10 to output a transformed voltage duty cycle 41. The driving unit 40 may be a NN or NP power transistor. The transformed voltage duty cycle 41 is input to a transformer 50 which transforms the voltage of the input electricity 11 according to the transformed voltage duty cycle 41, and outputs driving electricity to drive the load 60. The transformer 50 may consist of one or a plurality of piezoelectric transformers or winding transformers. A voltage feedback signal 51 is captured from the connection line that links the driving unit 40, the transformer 50, and the load 60, and sent to the micro-controller 20. The voltage feedback signal can be captured through a component of voltage via a resistor 52, or through an electrode taught in U.S. Pat. No. 6,867,955. When the micro-controller 20 receives the voltage feedback signal 51, it goes through the logic process to determine whether to output the protection signal 22 to the PWM control unit 30 to stop output of the electricity conduction cycles G1 and G2, thereby to cutoff electricity of the transformer 50 and the load 60. Moreover, a current feedback signal 61 may also be captured from the connection line that links the driving unit 40, transformer 50 and load 60 through a component of voltage via another resistor 62 (an optical induction means) that is sent to the micro-controller 20 to regulate the dimming duty cycle 21. According to the technique provided by the invention, the micro-controller 20 can respond instantly abnormal voltage condition and provide protection actions rapidly. Moreover, the invention does not need to add extra electronic elements such as the signal amplifier or silicon rectifier. Design of the entire circuit layout can be simplified.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An inverter driving circuit connecting electrically a power supply and a load, comprising:
a micro-controller to receive an external dimming signal and output a dimming duty cycle and a protection signal;
a pulse-wide modulation (PWM) control unit to receive the dimming duty cycle and output electricity conduction cycles, and to be triggered and activated by the protection signal;
a driving unit to receive the electricity conduction cycles and switch input electricity to output a transformed voltage duty cycle; and
a transformer to receive the transformed voltage duty cycle and transform the voltage of the input electricity, and output driving electricity to drive the load;
wherein the driving unit, the transformer and the load are linked by a connection line on which a voltage feedback signal is captured to trigger the micro-controller to output the protection signal.

2. The inverter driving circuit of claim 1, wherein the voltage feedback signal is captured through a component of voltage via a resistor.

3. The inverter driving circuit of claim 1 further having a current feedback signal which is captured from the connection line and sent to the micro-controller.

4. The inverter driving circuit of claim 3, wherein the current feedback signal is captured through a component of voltage via another resistor.

5. The inverter driving circuit of claim 1, wherein the load is a gas discharge lamp.
